(19) United States
(12) Patent Application Publication
(10) Pub. No.: US 2025/0101230 A1
(43) Pub. Date: Mar. 27, 2025

(54) METHOD FOR MANUFACTURING BAMBOO PLASTIC COMPOSITE MATERIAL

(71) Applicant: M.J.INTERNATIONAL FLOORING AND INTERIOR PRODUCTS INC., New Taipei City (TW)

(72) Inventor: BEN-YUAN CHEN, New Taipei City (TW)

(21) Appl. No.: 18/474,896

(22) Filed: Sep. 26, 2023

(51) Int. Cl. C08L 97/02; B29C 48/00; B29C 48/07; B29C 48/305; B29K 27/06; B29K 511/14; C08J 3/00; C08J 5/18; C08K 3/26; C08L 27/06

(52) U.S. Cl. CPC C08L 97/02; B29C 48/022; B29C 48/07; B29C 48/305; C08J 3/005; C08J 5/18; C08K 3/26; C08L 27/06; B29K 2027/06; B29K 2511/14; C08J 2327/06; C08J 2397/02; C08J 2423/28; C08J 2425/12; C08J 2427/06; C08K 2003/265; C08L 2201/08; C08L 2205/025; C08L 2205/035; C08L 2205/06

(57) ABSTRACT

A method for manufacturing bamboo plastic composite material having steps of cutting multiple bamboo stalks into multiple bamboo pieces and grinding the bamboo pieces to form multiple bamboo powders; cleaning the bamboo powders; drying the bamboo powers; modifying the bamboo powders; mixing multiple raw materials to form a bamboo plastic composite material with a composition of PVC 10 to 20 wt %; vinyl chloride/vinyl acetate (VC/VAC) copolymer 10 to 30 wt %; styrene-acrylonitrile copolymer (SAN) 1 to 5 wt %; chlorinated polyethylene (CPE) 1 to 5 wt %; the bamboo powders 10 to 40 wt %; inorganic filler 10 to 40 wt %; internal lubricant 0.1 to 1 wt %; external lubricant 0.1 to 1 wt %; and heat stabilizer 1 to 5 wt %; and forming and molding the bamboo plastic composite material.

### FIELD OF INVENTION

The present invention relates to a method for manufacturing a plastic composite material, particularly a method for manufacturing a plastic composite material containing a high amount of bamboo powders.

### BACKGROUND OF THE INVENTION

The excessive use of plastics by society is resulting in a range of problems that cannot be ignored. From environmental degradation to health hazards, the consequences of plastic overconsumption are significant. Plastic waste clogs landfills, pollutes oceans, and threatens ecosystems and wildlife. Additionally, the production and disposal of plastics cause greenhouse gas emissions, exacerbating climate change.

On the other hand, bamboo's fast growth necessitates regular thinning, which generates a significant amount of waste that needs careful management. Unlike some other materials, bamboo does not easily decompose in landfills due to its dense and fibrous nature.

Therefore, it is essential to find a solution that effectively reduces plastic usage and repurposes wasted bamboo.

### SUMMARY OF THE INVENTION

Therefore, it is a primary objective of the present invention to provide a method for manufacturing bamboo plastic composite material comprising steps of: cutting multiple bamboo stalks into multiple bamboo pieces and grinding the bamboo pieces to form multiple bamboo powders; cleaning the bamboo powders; drying the bamboo powders to make water content of the bamboo powders below 12 wt %; modifying the bamboo powders; and mixing multiple raw materials to form a bamboo plastic composite material, wherein the raw materials comprises: the bamboo powders 10 to 40 wt %; polyvinyl chloride (PVC) 10 to 20 wt %; vinyl chloride/vinyl acetate (VC/VAC) copolymer 10 to 30 wt %; styrene-acrylonitrile copolymer (SAN) 1 to 5 wt %; chlorinated polyethylene (CPE) 1 to 5 wt %; internal lubricant 0.1 to 1 wt %; external lubricant 0.1 to 1 wt %; and heat stabilizer 1 to 5 wt %.

Wherein, the method further comprises steps of: extruding the bamboo plastic composite material with a twin screw extruder, wherein the twin screw extruder comprises multiple mixing sections; and molding the bamboo plastic composite material into a sheet or a plate through an extrusion die, wherein the extrusion die comprises an extrusion channel with multiple molding sections.

Wherein, the extrusion die comprises nine molding sections with different temperatures and extrusion rates.

Wherein, the lengths of the bamboo powders are within a range of 0.1 millimeter to 0.8 millimeter.

Wherein, the step of cleaning the bamboo powders comprises soaking the bamboo powders in the alkaline solution for 6 to 12 hours and then rinse with water.

Wherein, a solute of the alkaline solution comprises calcium hydroxide, potassium hydroxide, or sodium hydroxide, and the concentration of the solvent of the alkaline solution is 3 to 10 wt %.

Wherein, the step of modifying the bamboo powders comprises placing the bamboo powers into a kiln, wherein the kiln is heated to 150 to 250° C. for 3 to 8 hours with a maximum heating ramp rate of 2° C. per minute with less than 8% of oxygen of atmosphere in the kiln.

Wherein, the step of modifying the bamboo powders comprises immersing the bamboo powders in acetic anhydride within a reactor, wherein the reactor is heated to 100 to 120° C. for 1 hour to 8 hours with the vapor being constantly removed.

Wherein, pyridine is added in the reactor and mixed with acetic anhydride.

Wherein, the method further comprising steps of applying an acrylic coating on the surface of the bamboo plastic composite material and curing with ultraviolet light after extrusion and molding.

### BRIEF DESCRIPTION OF THE DRAWINGS

FIG. 1A is a side view of an extruder for processing a bamboo plastic composite material in accordance with the present invention;

FIG. 1B is a top view of a conical twin screw extruder of an extruder in accordance with the present invention;

FIG. 2A is an illustrate figure of an extrusion die for processing a bamboo plastic composite material in accordance with the present invention;

FIG. 2B is an illustrate figure of an extrusion die for processing a bamboo plastic composite material in accordance with the present invention; and

FIG. 3 is an illustrate figure of a plastic flooring using a bamboo plastic composite material in accordance with the present invention.

### DETAILED DESCRIPTION OF THE PREFERRED EMBODIMENTS

In order to enhance comprehension and clarity regarding the present invention, a sequential description of a method for manufacturing bamboo plastic composite material shall be provided. It is important to note that the subsequent methods outlined below represents preferred embodiments, while recognizing that other rational modifications to the process or steps, whether similar or identical, fall within the scope of the present invention.

The method for manufacturing bamboo plastic composite material in accordance with this invention includes a series of sequential steps, as stated in the following paragraphs.

Step S10: Cutting multiple bamboo stalks into multiple bamboo pieces and grinding the bamboo pieces to form multiple bamboo powders. In step S10, multiple bamboo pieces are meticulously ground using a grinding machine or a mill to produce multiple bamboo powders. Preferably, the bamboo pieces are not dried before the grinding process, certain moisture content is retained for optimal processing. In this approach, the bamboo pieces contain approximately 30 percent of water in their weight. This moisture content aids in the grinding process by facilitating smoother and more efficient particle size reduction. The presence of water helps prevent excessive heat buildup during grinding, which can negatively affect the quality and properties of the resulting bamboo powders. Therefore, in this preferred embodiment, the bamboo pieces are directly fed into the grinding machine or the mill without prior drying to ensure the preservation of their natural moisture content throughout the process. Preferably, the lengths of the bamboo powders are controlled within a range of 0.1 to 0.8 mm. Sieving can also be performed to remove oversized particles.

Step S20: Cleaning the bamboo powders. In step S20, the bamboo powders are subjected to a thorough cleaning process to ensure the purity and suitability of the bamboo powders for use in the manufacturing process. Preferably, an alkaline treatment is performed to cleanse the bamboo powders. In a preferred embodiment, the bamboo powders are subjected to an alkaline solution for 6 to 12 hours and later rinse with water to effectively remove lipophilic substances, pectin, lignin, and waxes from the fiber surface of the bamboo powders. Preferably, the alkaline solution is a solution with a solute of calcium hydroxide, potassium hydroxide, or sodium hydroxide, and the concentration of the solution is preferably 3 to 10 wt %. Furthermore, step S20 can be performed with heating the alkaline solution to 45 to 50° C. during the process. The alkaline treatment induces a peeling reaction to roughen the surface of the bamboo powders and to increase the surface area of the bamboo powders.

Step S30: Drying the bamboo powders. In step S30, the bamboo powders are dried to make water content of the bamboo powders below 12 wt %. Preferably, the bamboo powders are placed into a kiln, and the kiln is heated gradually, and the temperature is carefully controlled throughout the drying process. Preferably, the kiln is heated to 45 to 80° C. As the temperature of the kiln increases, moisture within the bamboo powders begins to evaporate. The evaporated moisture is then removed from the kiln through a ventilation system or dehumidifiers to dry the bamboo powders to the desired water content.

Step S40: Modifying the bamboo powders. In step S40, once the bamboo powders are dried, the bamboo powders are modified to improve the physical, mechanical, and chemical properties of the bamboo powders.

In one preferred embodiment, the bamboo powders undergo heat treatment. The bamboo powders are placed into the kiln, and the kiln is further heated to 150 to 250° C. for 3 to 8 hours with a maximum heating ramp rate of 2° C. per minute and natural cooling after the heat treatment. Preferably, the bamboo powders are placed in the kiln with less than 8% of oxygen of the atmosphere in the kiln.

In another preferred embodiment, the bamboo powders undergo acetylation. The bamboo powders are immersed in acetic anhydride within a reactor and heated to 100 to 120° C. for 1 to 8 hour(s) with the vapor being constantly removed. Preferably, pyridine is also added in the reactor. Pyridine is used to remove the side product formed in the acylation reaction. The bamboo powders are then rinsed with water and repeat step S30 to dry the bamboo powders.

Step S50: Mixing multiple raw materials to form a bamboo plastic composite material. In step S50, the bamboo powders are mixed with other ingredients to form the bamboo plastic composite material. The bamboo plastic composite material have formula as follows:
the bamboo powders 10 to 40 wt %;
polyvinyl chloride (PVC) 10 to 20 wt %;
vinyl chloride/vinyl acetate (VC/VAC) copolymer 10 to 30 wt %;
styrene-acrylonitrile copolymer (SAN) 1 to 5 wt %;
chlorinated polyethylene (CPE) 1 to 5 wt %;
inorganic filler 10 to 40 wt %;
internal lubricant 0.1 to 1 wt %;
external lubricant 0.1 to 1 wt %; and
heat stabilizer 1 to 5 wt %.

In step S50, using a twin screw extruder 10, such as a conical twin screw extruder to heat and knead bamboo plastic composite material with the abovementioned formula. The twin screw extruder 10 in a barrel have multiple mixing sections with different temperature including a feeding section 11, a plasticizing section 12, a compression section 13, a vent section 14 and a metering section 15. The twin screw extruder 10 blends bamboo plastic composite material in a heating barrel. After passing the metering section 15, bamboo plastic composite material is collected and further introduced to a confluence core 16.

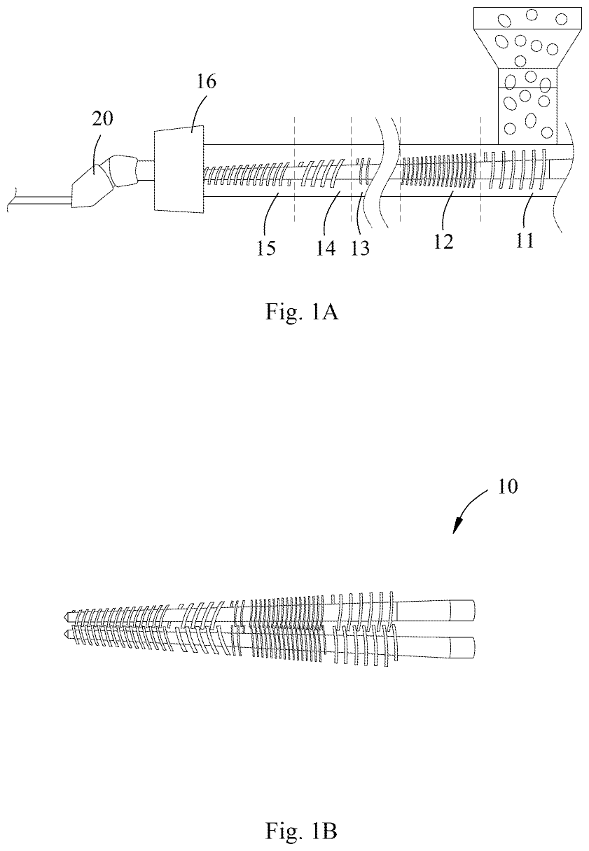

Specifically, step S50 can be performed as firstly to measure all raw materials of the bamboo plastic composite material according to the formula as mentioned above, and to feed the bamboo plastic composite material into a high-speed mixer to stir and mix at 1000 rpm for 5 minutes. During the mixing, the temperature of the bamboo plastic composite material does not exceeds 135° C. to avoid any pre-reaction. Preferably, the bamboo plastic composite material is stirred with a low-speed mixer and stirred at a low speed to ensure the temperature of the bamboo plastic composite material is below 45° C., followed by transporting the mixed materials to a hopper connected with the feeding section 11. The conical twin screw extruder (as shown in the top view of FIG. 1B) in the barrel is pre-set with an appropriate processing temperature (at a range of 140 to 160° C.) in different sections. When the temperature reaches the set temperature, the feeding and mixing the bamboo plastic composite material starts.

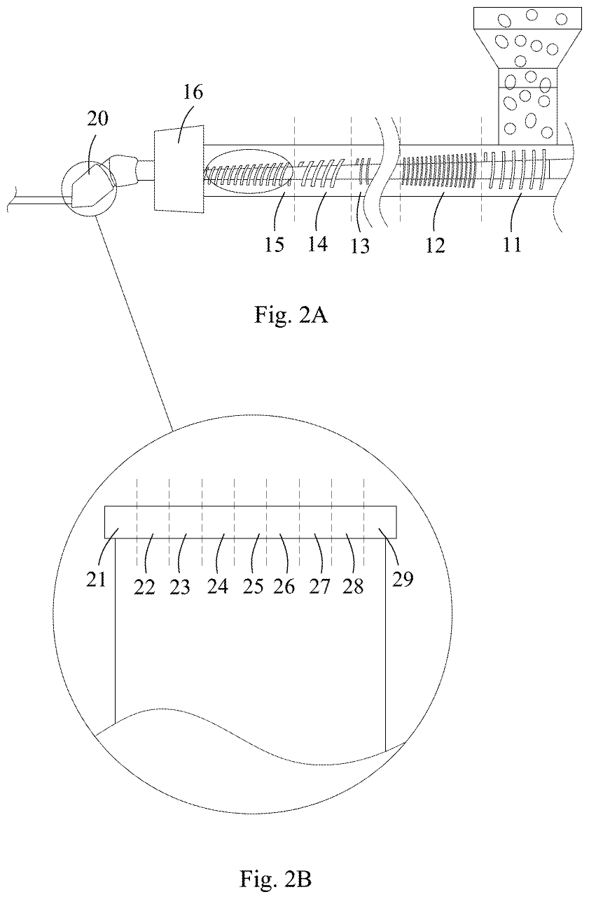

Step S60 (optional): Forming the bamboo plastic composite material. The end of the confluence core 16 of the twin screw extruder 10 is connected to an extrusion die 20, such as a T-die, for shaping and forming the bamboo plastic composite material into final product. The extrusion die 20 has an extrusion channel with a flat slit opening extending in the horizontal direction at its end to receive the bamboo plastic composite material and output the bamboo plastic composite material into a sheet or plate form. Such extrusion channel is set in a horizontal direction (or transverse direction) with several different molding sections with different temperature. In a preferred embodiment, nine molding sections are designed for the extrusion channel for controlling a melt fluidity of the bamboo plastic composite. Preferably, multiple adjusting rods are used for adjusting the uniformity of the flow of the bamboo plastic composite material. As shown in FIG. 2A and FIG. 2B, the molding sections from left to right direction includes a first forming section 21, a second forming section 22, a third forming section 23, a fourth forming section 24, a fifth forming section 25, a sixth forming section 26, a seventh forming section 27, an eighth forming section 28, and a ninth forming section 29. The extrusion die 20 processes the bamboo plastic composite material into a flat and even plate or sheet in a pre-set thickness using the molding sections. Preferably, the temperature and the extrusion rate of the nine molding sections are different according to the properties of the bamboo plastic composite material. The temperature of the middle sections (such as the fifth forming section 25 and the sixth forming section 26) is set slightly lower than the temperature of the section at two sides (e.g., the first forming section 21, the second forming section 22, the third forming section 23 at left side and the seventh forming section 27, the eighth forming section 28, and the ninth forming section 29 on the right) to reduce the extrusion speed of the middle section so as to be closed to the speed as the sections at the sides for stabling the flow and producing even and flat plate or sheet.

Step S70: Producing a finished product/semi-finished product. In step S70, the extruded flat plate or sheet can continue to be processed as a finished product on the same production line to become, for example, a flooring or a decorative wallboard.

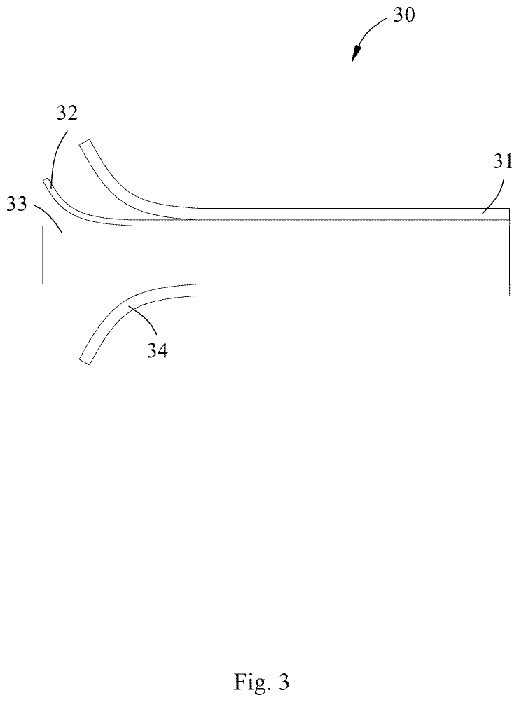

In one preferred embodiment, with reference to FIG. 3, a plastic flooring 30 of the present invention is presented. The bamboo plastic composite material as mentioned above is produced as core sheet to be further laminated with other functional layers includes:
a wear layer 31, wherein the wear layer 31 is a polyvinyl chloride (PVC) sheet and the wear layer 31 is transparent;
a print layer 32;
a core layer 33, wherein the core layer 33 contains the bamboo plastic composite material; and
a foamed layer 34 for sound insulation, wherein the foamed layer 34 comprises irradiation cross-linked polyethylene (IXPE) foam pads.

To produce the plastic flooring 30, in one preferred embodiment, a roll-to-roll production method including steps of putting the print layer 32 and the wear layer 31 in a sheet roll on a rack above and below; and continuously discharging the core sheet 33 dragged by a traction wheel and a laminated wheel for continuous production. It is preferred that the print layer 32 and the wear layer 31 are pre-heated to be adhered on both sides of the core sheet 33 by wheel pressing. In addition, the core sheet 33 still have some remaining or residual heat to have its surface maintain some adhesion ability to securely attached to the print layer 32 and the wear layer 31. Furthermore, according to the product requirements, a step of embossing could be applied to the surface of the final product by reheating the surface temperature through heating zone by the embossing wheel. This semi-finished product continues to be cooled down until the temperature reaches below 40° C.

Step S80 (optional): Post processing. In step S80, after cooling the semi-finished product to room temperature, coating the semi-finished product surface with an acrylic coating and curing the acrylic coating with an ultraviolet lamp to provide enhanced wear and scratch resistance layer on the surface. Then, the large semi-finished product is cut into pieces according to the required specifications and sizes by a sawing machine to form multiple floorings. Four sides of each flooring are milled with suitable grooves/tongues by a milling machine. The bottom surface of the flooring is adhered with the foamed layer 34. In one embodiment, the foamed layer 34 is an IXPE foam sheet with density between 0.08 and 0.18. The foamed layer 34 provides extra impact resistance and sound insulation functions. Preferably, the overall thickness of the final plastic flooring 30 is at a range of 5.0-7.0 mm with the thickness of the wear layer 31 is at a range of 0.30-0.80 mm, and the thickness of the foamed layer 34 for sound insulation is at a range of 1.0-1.5 mm.

The internal lubricant and the external lubricant in the bamboo plastic composite material in the present invention play different roles. The internal lubricant is mainly for reducing the frictional force that occurs within the PVC molecular chains and could reduce the melt viscosity. It is preferred to be a polar polyfatty acid ester, such as ethylene glycol fatty acid esters, pentaerythritol fatty acid esters, phthalic acid fatty acid esters, and the like, which are materials highly compatible with PVC. The external lubricant otherwise reduces the adhesion between the PVC and the metal surface of the processing equipment. It comprises non-polar material, such as polyethylene wax. Furthermore, the VC/VAC copolymer in the present invention can reduce the processing temperature of the plastic melt by at least 50° C. compared with the existing PVC formulation and production method, which effectively reduce the energy consumption and prevent the bamboo powders from being overheated or even burnt during the heating process due to high temperature.

### First Preferred Embodiment

Table 1 shows the formula of the bamboo plastic composite material in the first preferred embodiment in accordance with the present invention.

TABLE 1

| Materials | Content (Kg) | Proportion (wt %) |
|---|---|---|
| Polyvinyl chloride (PVC) | 45 | 17.1 |
| Vinyl chloride/vinyl acetate | 35 | 13.3 |
| (VC/VAC) copolymer | | |
| Styrene-acrylonitrile copolymer | 2 | 0.76 |
| (SAN) | | |
| Chlorinated polyethylene (CPE) | 3 | 1.14 |
| Calcium carbonate | 120 | 45.6 |
| Bamboo powder | 50 | 19.0 |
| Internal lubricant | 0.9 | 0.34 |
| External lubricant | 1.1 | 0.42 |
| Heat stabilizer | 6 | 2.28 |
| Total amount | 263.0 | 100 |

Step S51: setting the twin screw extruder 10 in suitable temperature. In the first preferred embodiment, the bamboo plastic composite material is uniformly stirred, mixed and kneaded with the conical twin screw extruder, and the mixing sections of this conical twin screw extruder is defined as 5 sections and the preferred to have a confluence core at the end. The temperature of each mixing section is shown in table 2 below. After the equipment reaches the pre-set temperature, the composition is fed for processing. The speed of the conical twin screw extruder is around 10 rpm. The electric current is applied with 150 to 180A. The back pressure of the melt is about 1.6 to 2.0 MPa. The followed extrusion die 20 extrudes the melt into a plate or sheet at a rate around 1020 kg/hour.

TABLE 2

| Section | Temperature (° C.) |
|---|---|
| 1 | 160 |
| 2 | 160 |
| 3 | 160 |
| 4 | 160 |
| 5 | 160 |
| Confluence core | 150 |

Step S61: The extrusion channel of the extrusion die 20 is divided into 9 sections. The processing temperature of each section is pre-set at the range 160-190° C. The extrusion speed of each section may also be different to produce a high quality flat sheet or a plate material. Furthermore, the sheet product is processed by the post-processing as mentioned above.

### Second Preferred Embodiment

Table 3 shows the formula of the bamboo plastic composite material in the first preferred embodiment in accordance with the present invention.

TABLE 3

| Materials | Content (Kg) | Proportion (wt %) |
|---|---|---|
| Polyvinyl chloride (PVC) | 30 | 12.8 |
| Vinyl chloride/vinyl acetate | 50 | 21.3 |
| (VC/VAC) copolymer | | |
| Styrene-acrylonitrile copolymer | 3 | 1.28 |
| (SAN) | | |
| Chlorinated polyethylene (CPE) | 4 | 1.70 |
| Calcium carbonate | 70 | 29.8 |
| Bamboo powder | 70 | 29.8 |
| Internal lubricant | 1.2 | 0.51 |
| External lubricant | 1 | 0.43 |
| Heat stabilizer | 6 | 2.55 |
| Total amount | 235.2 | 100 |

Step S52: setting the twin screw extruder 10 in suitable temperature. In the first preferred embodiment, the bamboo plastic composite material is uniformly stirred, mixed and kneaded with the conical twin screw extruder, and the mixing sections of this conical twin screw extruder is defined as 5 sections and the preferred to have a confluence core at the end. The temperature of each mixing section is shown in table 4 below. After the equipment reaches the pre-set temperature, the composition is fed for processing. The speed of the conical twin screw extruder is around 10 rpm. The electric current is applied with 150 to 180A. The back pressure of the melt is about 1.6 to 2.0 MPa. The followed extrusion die 20 extrudes the melt into a plate or sheet at a rate around 920 kg/hour.

TABLE 4

| Section | Temperature (° C.) |
|---|---|
| 1 | 160 |
| 2 | 160 |
| 3 | 160 |
| 4 | 160 |
| 5 | 160 |
| Confluence core | 150 |

Step S62: The extrusion channel of the extrusion die 20 is divided into 9 sections. The processing temperature of each section is pre-set at the range 160-190° C. The extrusion speed of each section may also be different to produce a high quality flat sheet or a plate material. Furthermore, the sheet product is processed by the post-processing as mentioned above.

### Third Preferred Embodiment

Table 5 shows the formula of the bamboo plastic composite material in the first preferred embodiment in accordance with the present invention.

TABLE 5

| Materials | Content (Kg) | Proportion (wt %) |
|---|---|---|
| Polyvinyl chloride (PVC) | 30 | 12.8 |
| Vinyl chloride/vinyl acetate | 50 | 21.3 |
| (VC/VAC) copolymer | | |
| Styrene-acrylonitrile copolymer | 4 | 1.70 |
| (SAN) | | |
| Chlorinated polyethylene (CPE) | 3 | 1.28 |
| Calcium carbonate | 90 | 38.3 |
| Bamboo powder | 50 | 21.3 |
| Internal lubricant | 1.2 | 0.51 |
| External lubricant | 0.8 | 0.34 |
| Heat stabilizer | 6 | 2.55 |
| Total amount | 235.0 | 100 |

Step S53: setting the twin screw extruder 10 in suitable temperature. In the first preferred embodiment, the bamboo plastic composite material is uniformly stirred, mixed and kneaded with the conical twin screw extruder, and the mixing sections of this conical twin screw extruder is defined as 5 sections and the preferred to have a confluence core at the end. The temperature of each mixing section is shown in table 6 below. After the equipment reaches the pre-set temperature, the composition is fed for processing. The speed of the conical twin screw extruder is around 10 rpm. The electric current is applied with 150 to 180A. The back pressure of the melt is about 1.6 to 2.0 MPa. The followed extrusion die 20 extrudes the melt into a plate or sheet at a rate around 970 kg/hour.

TABLE 6

| Section | Temperature (° C.) |
|---|---|
| 1 | 160 |
| 2 | 160 |
| 3 | 160 |
| 4 | 160 |
| 5 | 160 |
| Confluence core | 150 |

Step S63: The extrusion channel of the extrusion die 20 is divided into 9 sections. The processing temperature of each section is pre-set at the range 160-190° C. The extrusion speed of each section may also be different to produce a high quality flat sheet or a plate material. Furthermore, the sheet product is processed by the post-processing as mentioned above.

The abovementioned three preferred embodiments in accordance with the present invention provide bamboo plastic composite material to be used in a sheet product as a core layer to be laminated with other surface material. As the embodiment mentioned above, the bamboo plastic composite core layer is laminated with a PVC print layer and a PVC wear layer on the surface to form a decorative panel, which can be applied to floors or wall constructions. Furthermore, the laminates could adhere with IXPE foam insulation layer to provide impact resistant and sound insulation properties.

Based on the aforementioned description, methods in accordance with the present invention have the following advantages:
1. Enhanced strength and stiffness. Bamboo fibers are known for their high strength-to-weight ratio and stiffness. By incorporating bamboo powders into plastic, the resulting composite can exhibit improved mechanical properties, including increased strength and stiffness, compared to pure plastic.
2. Weight reduction. Bamboo powders are lightweight and can thus help to reduce the overall weight of the bamboo plastic composite material.
3. Environmental sustainability. Bamboo is a renewable resource that grows rapidly and has a low environmental impact compared to traditional reinforcing materials like fiberglass or carbon fiber.
4. Cost-effectiveness. Bamboo powders are often more cost-effective compared to other reinforcing materials. Incorporating bamboo powders into plastic can offer a cost-efficient solution while maintaining desirable mechanical properties.
5. Improved stability. The bamboo powders can help reduce the dimensional changes caused by temperature and moisture variations in the plastic matrix. Surface modification reduces the hydrophilic nature of bamboo powders, making them more resistant to water uptake and less prone to dimensional changes or degradation caused by moisture. This can result in improved stability and reduced warping or deformation of the composite material, extending the longevity of the bamboo plastic composite material products made with the methods of this invention.
6. Improved adhesion. Surface modification treatments, such as acetylation or chemical treatments in methods of this invention can enhance the compatibility between bamboo fibers and the plastic matrix. This improved adhesion ensures better stress transfer between the fibers and the plastic, resulting in increased strength and durability of the bamboo plastic composite material.
7. Improved energy efficiency and quality. By first transforming bamboo into powders and then drying them, the surface area of the material increases significantly. This enhanced surface area facilitates better evaporation and moisture removal during the drying process, leading to more efficient and thorough drying. Additionally, drying bamboo powders allows for better control over the drying conditions, such as temperature and airflow, as the powders have a larger exposed surface that can be evenly exposed to the drying environment. This controlled drying process helps to prevent moisture retention and reduces the likelihood of mold or fungal growth, ensuring the preservation of the bamboo powders.

What is claimed is:

1. A method for manufacturing bamboo plastic composite material comprising steps of:
cutting multiple bamboo stalks into multiple bamboo pieces and grinding the bamboo pieces to form multiple bamboo powders;
cleaning the bamboo powders;
drying the bamboo powders to make water content of the bamboo powders below 12 wt %;
modifying the bamboo powders; and
mixing multiple raw materials to form a bamboo plastic composite material, wherein the raw materials comprise:
the bamboo powders 10 to 40 wt %;
polyvinyl chloride (PVC) 10 to 20 wt %;
vinyl chloride/vinyl acetate (VC/VAC) copolymer 10 to 30 wt %;
styrene-acrylonitrile copolymer (SAN) 1 to 5 wt %;
chlorinated polyethylene (CPE) 1 to 5 wt %;
internal lubricant 0.1 to 1 wt %;
external lubricant 0.1 to 1 wt %; and
heat stabilizer 1 to 5 wt %.

2. The method for manufacturing bamboo plastic composite material according to claim 1 further comprising steps of:
extruding the bamboo plastic composite material with a twin screw extruder, wherein the twin screw extruder comprises multiple mixing sections; and
molding the bamboo plastic composite material into a sheet or a plate by an extrusion die, wherein the extrusion die comprises an extrusion channel with multiple molding sections.

3. The method for manufacturing bamboo plastic composite material according to claim 2, wherein the extrusion die comprises nine molding sections with different temperatures and extrusion rates.

4. The method for manufacturing bamboo plastic composite material according to claim 1, wherein the lengths of the bamboo powders are within a range of 0.1 millimeter to 0.8 millimeter.

5. The method for manufacturing bamboo plastic composite material according to claim 2, wherein the lengths of the bamboo powders are within a range of 0.1 millimeter to 0.8 millimeter.

6. The method for manufacturing bamboo plastic composite material according to claim 1, wherein the step of cleaning the bamboo powders comprises soaking the bamboo powders in the alkaline solution for 6 to 12 hours and then rinse with water.

7. The method for manufacturing bamboo plastic composite material according to claim 2, wherein the step of cleaning the bamboo powders comprises soaking the bamboo powders in the alkaline solution for 6 to 12 hours and then rinse with water.

8. The method for manufacturing bamboo plastic composite material according to claim 4, wherein the step of cleaning the bamboo powders comprises soaking the bamboo powders in the alkaline solution for 6 to 12 hours and then rinse with water.

9. The method for manufacturing bamboo plastic composite material according to claim 1, wherein a solvent of the alkaline solution comprises calcium hydroxide, potassium hydroxide, or sodium hydroxide, and the concentration of the solute of the alkaline solution is 3 to 10 wt %.

10. The method for manufacturing bamboo plastic composite material according to claim 6, wherein a solvent of the alkaline solution comprises calcium hydroxide, potassium hydroxide, or sodium hydroxide, and the concentration of the solute of the alkaline solution is 3 to 10 wt %.

11. The method for manufacturing bamboo plastic composite material according to claim 1, wherein the step of modifying the bamboo powders comprises placing the bamboo powers into a kiln, wherein the kiln is heated to 150 to 250° C. for 3 to 8 hours with a maximum heating ramp rate of 2° C. per minute with less than 8% of oxygen of atmosphere in the kiln.

12. The method for manufacturing bamboo plastic composite material according to claim 2, wherein the step of modifying the bamboo powders comprises placing the bamboo powers into a kiln, wherein the kiln is heated to 150 to 250° C. for 3 to 8 hours with a maximum heating ramp rate of 2° C. per minute with less than 8% of oxygen of atmosphere in the kiln.

13. The method for manufacturing bamboo plastic composite material according to claim 6, wherein the step of modifying the bamboo powders comprises placing the bamboo powers into a kiln, wherein the kiln is heated to 150 to 250° C. for 3 to 8 hours with a maximum heating ramp rate of 2° C. per minute with less than 8% of oxygen of atmosphere in the kiln.

14. The method for manufacturing bamboo plastic composite material according to claim 1, wherein the step of modifying the bamboo powders comprises immersing the bamboo powders in acetic anhydride within a reactor, wherein the reactor is heated to 100 to 120° C. for 1 hour to 8 hours with the vapor being constantly removed.

15. The method for manufacturing bamboo plastic composite material according to claim 2, wherein the step of modifying the bamboo powders comprises immersing the bamboo powders in acetic anhydride within a reactor, wherein the reactor is heated to 100 to 120° C. for 1 hour to 8 hours with the vapor being constantly removed.

16. The method for manufacturing bamboo plastic composite material according to claim 6, wherein the step of modifying the bamboo powders comprises immersing the bamboo powders in acetic anhydride within a reactor, wherein the reactor is heated to 100 to 120° C. for 1 hour to 8 hours with the vapor being constantly removed.

17. The method for manufacturing bamboo plastic composite material according to claim 14, wherein pyridine is added in the reactor and mixed with acetic anhydride.

18. The method for manufacturing bamboo plastic composite material according to claim 2 further comprising steps of applying an acrylic coating on the surface of the bamboo plastic composite material and curing with ultraviolet light after extrusion and molding.

19. The method for manufacturing bamboo plastic composite material according to claim 3 further comprising steps of applying an acrylic coating on the surface of the bamboo plastic composite material and curing with ultraviolet light after extrusion and molding.

20. The method for manufacturing bamboo plastic composite material according to claim 4 further comprising steps of applying an acrylic coating on the surface of the bamboo plastic composite material and curing with ultraviolet light after extrusion and molding.
